(19) United States
(12) Patent Application Publication
(10) Pub. No.: US 2009/0167621 A1
(43) Pub. Date: Jul. 2, 2009

(54) Flat antenna

(75) Inventors: Miguel Beruete, Navarra (ES); Mario Sorolla, Navarra (ES); Igor Campillo, Vizcaya (ES); Jorge Sanchez, Vizcaya (ES)

Correspondence Address: SUGHRUE MION, PLLC, 2100 PENNSYLVANIA AVENUE, N.W., SUITE 800, WASHINGTON, DC, 20037, US

(73) Assignee: UNIVERSIDAD PUBLICA DE NAVARRA, PAMPLONA (ES)

(21) Appl. No.: 11/659,341

(22) PCT Filed: Aug. 3, 2004
(86) PCT No.: PCT/ES04/00359

§ 371 Date: Oct. 27, 2008

(51) Int. Cl. H01Q 13/10

(52) U.S. Cl. 343/767

(57) ABSTRACT

The present invention relates to antennas of a planar profile coupled to waveguides, and particularly to completely planar antennas, applicable in mobile telephony, radars and space communications, which base their operating on the transmission of electromagnetic waves, mainly in the range of microwaves and millimetric waves, through a thin opening of a height that is less than the wavelength, having corrugations around said opening such that maximized wave transmission as well as the collimation thereof in a defined direction towards leaky waves by means of a resonant coupling mechanism are obtained.

The present invention relates to antennas with a planar profile coupled to waveguides and particularly to completely planar antennas, applicable in mobile telephony, radars and space communications. Said planar antennas base their operation on the transmission of electromagnetic waves, mainly in the range of microwaves and millimetric waves, through a thin opening of a height that is less than the wavelength, having corrugations in the area surrounding said opening, such that maximized wave transmission as well as the collimation thereof in a defined direction towards leaky waves by means of a resonant coupling mechanism are achieved.

### BACKGROUND OF THE INVENTION

There are different antennas in the state of the art with different shapes and working modes the designs of which are usually aimed at a specific application, such as space communications, telephony, television and radar applications, among others.

Antennas are known that are based on microwave and millimetric planar circuit technology; for example European patent application EP-0910134-A discloses a planar antenna for microwave transmission. The antenna comprises at least one printed circuit and has active elements such as transmission lines and radiation elements. The antenna is made up of a plate and a box joined together and between which the antenna's printed circuit, a polarizer and a ground plate are arranged, all the elements being separated from one another by means of foam spacers. Despite being a planar antenna, in addition to not having the same structure and composition as the antenna object of the present invention, its operation is different and does not allow easy coupling of the waves from a waveguide to the antenna.

U.S. Pat. No. 6,639,566-B discloses a non-planar antenna based on waveguide horns for producing two polarized orthogonal signals. It consists of two separated parallel conductive plates for defining an internal opening for microwave signal transmission. It also has extensions coupled to the edges of the plates such that the openings in the extensions are directed towards the reflective surfaces of the antenna. A waveguide provides microwave signals, the power densities of which grow narrower due to the corrugated surface of the extensions. This patent is a background document in the field of antennas but the main difference with the antenna herein proposed is the different non-planar structure thereof, which prevents its application in the same conditions as the antenna object of the present invention.

International application WO-03019245-A discloses an apparatus for optical transmission with control of divergence and direction of light waves from at least one opening. Said apparatus comprises: light insensitive surface with at least one opening, a periodic or almost periodic topography on its surface comprising one or several features associated to said opening in which the light emerging from said opening interacts with surface waves on said surface, providing control over the direction and optical divergence of the emitted light. The main difference between this document and the planar antenna herein proposed is that despite describing a similar operation, it does not apply, nor does it suggest applying, the transmission of waves that are different to the optical wave range, and therefore it does not mention its application in the field of antennas either. Nor does it describe guiding the waves by means of the use of resonant couplings to improve the wave transmission. And lastly, nor does it mention the occurrence of transverse modes associated to the thin width of the slot.

The article “Granting less enhanced microwave transmission through a subwavelength aperture in a thick metal plate”, Applied Physics Letters, volume 81, pages 4661 to 4663, analyzes the improved transmission of radiation through a slot in a wide metal substrate, the slot being centered with respect to two grooves. Said article concludes that while the grooves on the illuminated surface can increase the total power flow through the slot, the grooves on the substrate surface can be used to restrict the direction of the beam to a limited angular range. This article does not mention the application of the technical working principle to antenna technology and by no means is resonant coupling from a waveguide to the corrugated groove used. Nor does it mention the occurrence of transverse modes associated to the thinness of the slot.

The article “Multiple paths to enhance optical transmission through a single subwavelength slit”, Physical Review Letters, volume 90, pages 213901-1 to 213901-3, analyzes the optical transmission properties of a slot in a corrugated metal plate. It concludes that there are three mechanisms improving transmission, the latter reaching its maximum stimulus when the three mechanisms cooperate, and possibly being controlled with the geometric parameters of the device. As in the previous documents, no reference is made to the application in antennas in any range other than the optical range, or to the use of wave guides, nor to the occurrence of transverse modes.

### DESCRIPTION OF THE INVENTION

The present invention describes an antenna with a planar profile which, by making use of the physical surface wave excitation mechanism on a corrugated structure and its focalization by means of a slot made on said surface, allows reducing the antenna plate size and operating with microwaves or millimetric waves propagating in free space given that it makes the handling thereof simpler and easier.

An object of the present invention is to obtain low profile, miniaturized planar antennas operating directly with guided waves, whether in a wire, a waveguide, a printed or monolithic circuit, etc., and allowing their emission and reception by making use of the previously described physical mechanism.

According to this object, the proposed antenna consists of a waveguide coupled to the radiated wave by means of a resonant slot made in a metallic plate having several corrugations. Radiation occurs upon transferring the power of the guided waves by means of resonant coupling towards leaky waves, i.e. those guided waves that allow emitting radiation simultaneously, supported by the corrugated plate.

A preferred embodiment consists of an antenna with a waveguide coupled by longitudinal resonance, i.e. by means of the thickness of the metallic plate separating the inside of the guide from free space. only one corrugation is included on the metallic plate for the purpose of minimizing structural dimensions.

Another embodiment consists of a planar antenna with a larger number of corrugations such that despite increasing the dimensions, better and greater focalization is obtained.

According to one embodiment, and specifically for the application of the antenna in mobile communication bands in the microwave range, the resulting wavelength is high, and therefore a compact design is unfeasible, though for millimetric wave frequencies, the described design is suitable since the thickness of the metallic plate is approximately a few millimeters. To obtain the use of planar antennas in the microwave range for mobile communications it is necessary to reduce the thickness of the metal, preserving the radiation features intact, and to that end the slot is made to resonate in its transverse dimension, directly related with the slot width, rather than longitudinally.

Another embodiment allows the design of a planar antenna with at least two pairs of corrugations, with the capacity to operate in two independent frequency bands, taking advantage of the fact that two independent resonances, longitudinal resonance and transverse resonance, can be excited in the slot. It is also possible to obtain the focus of the waves at different frequencies by means of controlling corrugation distance and depth. This construction allows obtaining a dual-band antenna the resonance frequencies of which can be fixed completely independently from one another by means of controlling central slot width and thickness. The gain increase is achieved by means of placing corrugations on the sides, each one of these corrugations being sensitive only to its design frequency whereas it is transparent for the other resonance.

Another embodiment includes, inside the cavity formed by the corrugations, a low loss dielectric material and suitable relative dielectric permittivity, such that it allows reducing antenna plate thickness. This embodiment allows making ultraplanar antennas.

According to another embodiment, an antenna is available without waveguide feed, consisting of a slot antenna on a high-frequency printed circuit board. In this embodiment, resonance of the slot is transversal, such as that previously described for reducing the thickness, and is surrounded by corrugated metallic plates, these being filled with a high dielectric permittivity substrate. This allows that compatibility with planar and monolithic circuit technology is assured by means of a completely planar design on a microwave substrate, with corrugations excavated on the substrate and subsequent metallization. It further allows the inclusion of via holes (metallization routes or holes through which ground connections between circuit plates are carried out), facilitating the connection between plates.

Finally, another embodiment consists of an antenna using concentric corrugations around the slot with transverse and longitudinal resonances, respectively.

### BRIEF DESCRIPTION OF THE DRAWINGS

Various configurations of corrugated planar profiles and the properties thereof are represented schematically and only by way of examples in the attached figures for greater understanding of the foregoing description.

FIG. 1a shows a diagram of a slot surrounded by corrugations on a metallic plate.

FIG. 1b shows the transmission results in plane E for a structure such as the one in FIG. 1a, measured in two configurations: the corrugated surface facing the emitter (dashed line with white squares) and facing the receiver (continuous line with black dots). Results are also shown for a plate with a slot without being surrounded by any corrugation (dotted line with inverted white triangles). The results confirm the improvement of transmission and channeling of the beam emitted for a structure such as the one of FIG. 1a.

FIG. 2a shows a plan view of a preferred form of the invention, highlighting the following design parameters: plate width (a), plate height (L), slot width (w), slot height (h), corrugation height (s) and distance between the slot and corrugation (d).

FIG. 2b shows respective side views of a preferred form of the invention, highlighting the following design parameters: plate thickness (E), waveguide height (b) and corrugation depth (p).

FIG. 3a shows a perspective view of a corrugated planar antenna coupled to a waveguide.

FIG. 3b shows a side view of FIG. 3b and the effect on the power density of the longitudinal resonance of the slot.

FIG. 3c shows the current density of a longitudinal resonance.

FIG. 3d shows the current density of a transverse resonance.

FIG. 3e shows simulated (gray line) and measured (black line) return losses with the frequency for both resonances.

FIG. 3f shows the simulation of the far-field radiation pattern in three-dimensional format for the first resonance in the absence of corrugations.

FIG. 3g shows the simulation of the far-field radiation pattern in three-dimensional format for the first resonance with the collimator effect of the corrugations.

FIG. 3h shows the simulation of the E-plane far-field radiation pattern in polar coordinates for the first resonance in the presence of corrugations.

FIG. 3i shows the simulation of the H-plane far-field radiation pattern in polar coordinates for the first resonance in the presence of corrugations.

FIG. 3j shows the simulation (continuous line) compared with the measurement (dotted line) of the E-plane far-field radiation pattern in Cartesian coordinates for the first resonance in the presence of corrugations.

FIG. 3k shows the simulation (continuous line) compared with the measurement (dotted line) of the H-plane far-field radiation pattern in Cartesian coordinates for the first resonance in the presence of corrugations.

FIG. 3l shows the comparison of the gain with respect to the isotropic antenna for the antenna object of the patent (bottom line) and a standard horn (top line).

FIG. 3m shows a photograph of several antennas object of the present invention.

FIG. 4a shows an antenna with an increase in corrugations with respect to the antenna of FIG. 2.

FIG. 4b shows an antenna such as the one of FIG. 4a but with asymmetrical corrugations.

FIG. 4c shows the simulation of the far-field radiation pattern in three-dimensional format of the antenna of FIG. 4a, in which a greater collimator effect can be observed than in an antenna with one corrugation.

FIG. 4d shows the simulation of the far-field radiation pattern in three-dimensional format of the antenna of FIG. 4b, in which collimation symmetry is observed with respect to the symmetrical antenna.

FIG. 5a shows a dual-band antenna.

FIG. 5b shows the surface current density on the radiating side for one of the operating frequencies of the dual-band antenna of FIG. 5a.

FIG. 5c shows the surface current density on the radiating side for the other operating frequency, different from that of FIG. 5b, in the dual-band antenna of FIG. 5a.

FIG. 5d shows a photograph of a dual-band antenna.

FIG. 6a shows an antenna in which a material with a high index of refraction has been introduced in the corrugations.

FIG. 6b shows a photograph of an ultraplanar antenna.

FIG. 7a shows an antenna with annular corrugations.

FIG. 7b shows the simulated (gray line) and measured (black line) return losses with the frequency.

FIG. 7c shows the simulation for the far-field radiation pattern in three-dimensional format.

FIG. 7d shows the simulation of the E-plan far-field radiation pattern in polar coordinates in which the strong collimating effect of the annular corrugations is observed.

FIG. 7e shows the simulation of the H-plane far-field radiation pattern in polar coordinates.

FIG. 7f shows the simulation (continuous line) compared with the measurement (dotted line) of the E-plane far-field radiation pattern in Cartesian coordinates.

FIG. 7g shows the simulation (continuous line) compared with the measurement (dotted line) of the H-plane far-field radiation pattern in Cartesian coordinates.

FIG. 7h shows the comparison of the gain with respect to the isotropic antenna for the antenna object of the patent (black line) and a standard horn (gray line).

FIG. 7i shows an antenna with annular corrugations.

### DESCRIPTION OF PREFERRED EMBODIMENTS

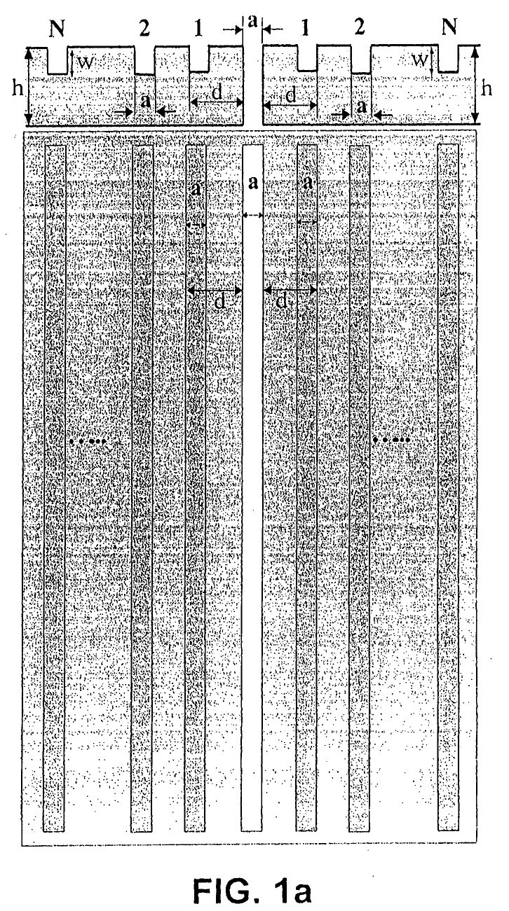

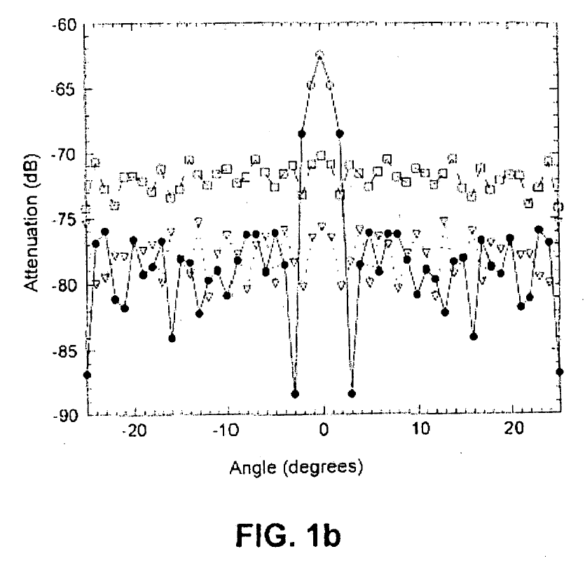

FIG. 1 shows a diagram of an antenna object of the present application consisting of a slot surrounded by an indefinite number of corrugations on either of its sides and arranged on a metallic plate. The performance of said antenna with regard to collimation and transmission in the E-plane can be observed in FIG. 1b. For the case of illuminating the structure with a planar wave, the comparison between the E-plane radiation pattern for the case of the absence of corrugations can be observed as a dotted line with inverted triangles, whereas for the case in which the corrugations are opposite to the wave source, it is represented as a dashed line with squares, and finally for the case in which the corrugations are on the opposite side, it appears as a dashed line with black dots. This is the case in which collimation of the emitted radiation occurs.

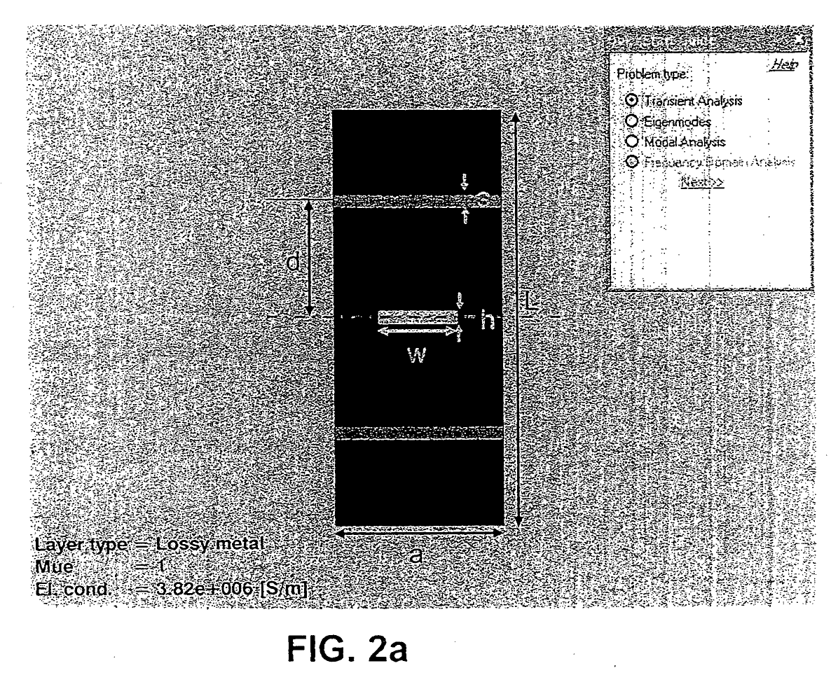

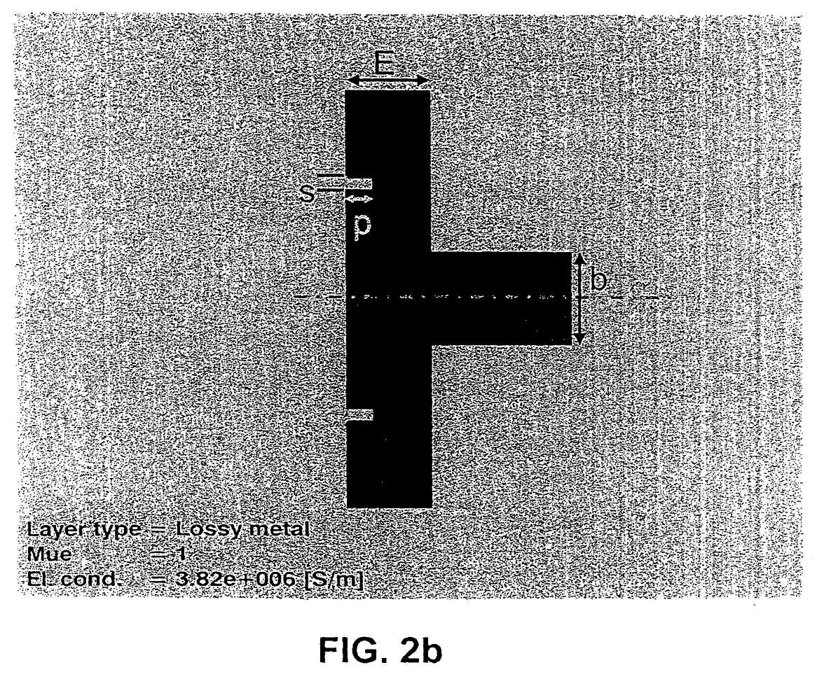

FIGS. 2a and 2b detail a planar antenna with a corrugation on each side of the slot and which resonates longitudinally. FIG. 2a shows the radiating transverse side, in which the length of the metallic plate L, its width a, which may coincide with the outer width of the feed waveguide, the width of the slot w, its height h, the distance of the corrugations to the axis of horizontal symmetry of the antenna d, and the height of said corrugations s, are detailed. FIG. 2b shows a longitudinal section of the antenna with the thickness E of the metallic plate, the outer height of the feed waveguide b, the depth of the corrugations p and their thickness s.

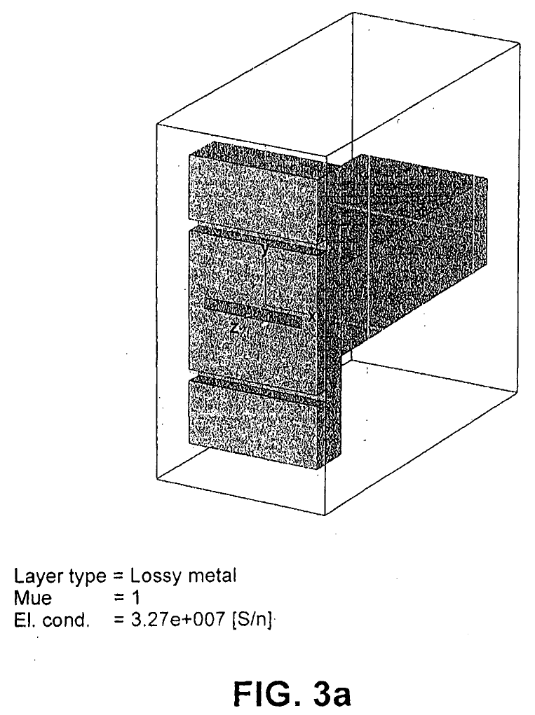

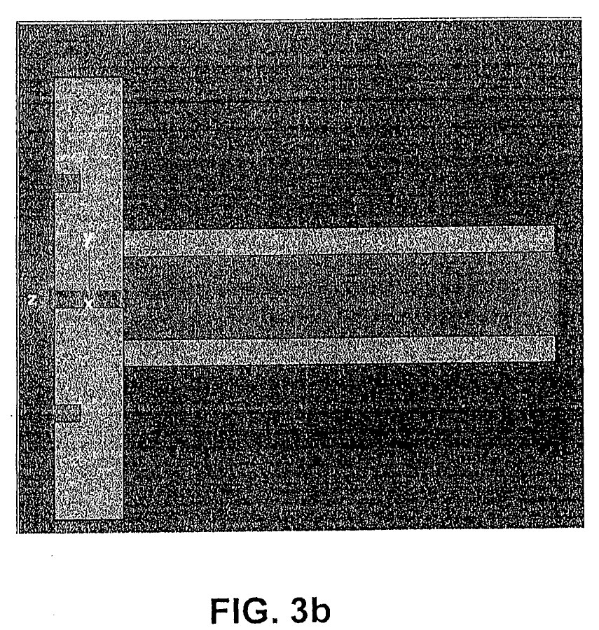

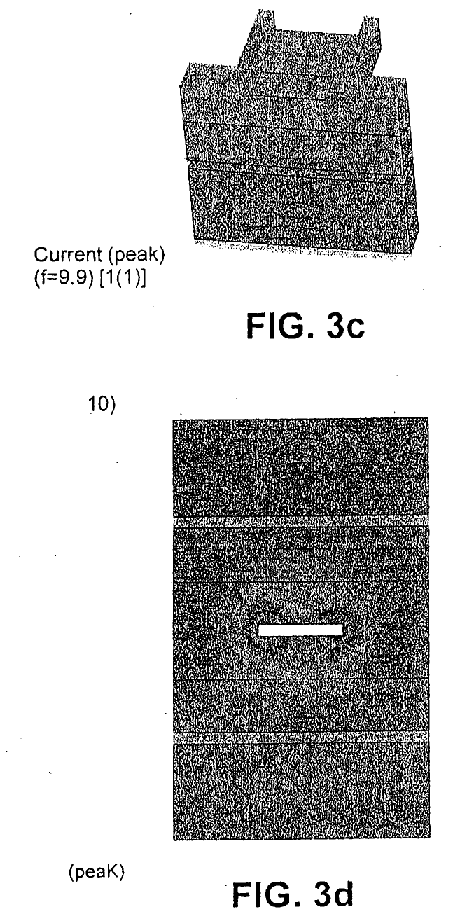

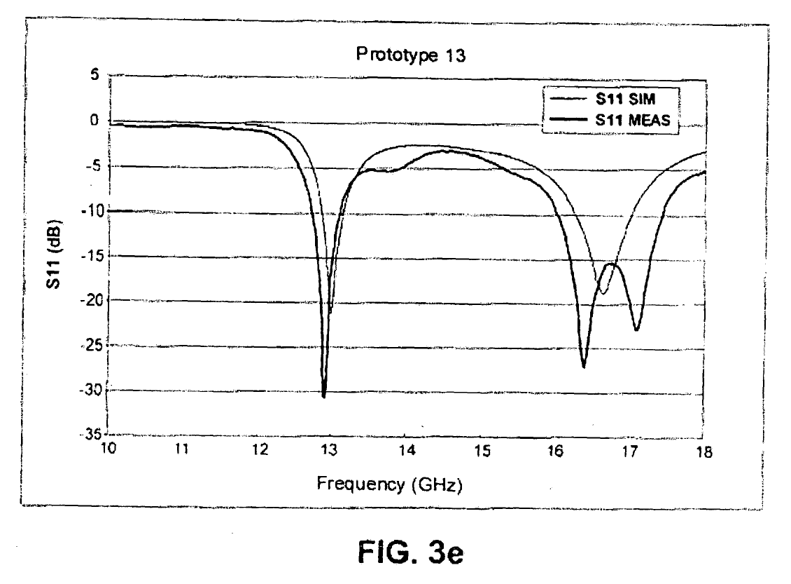

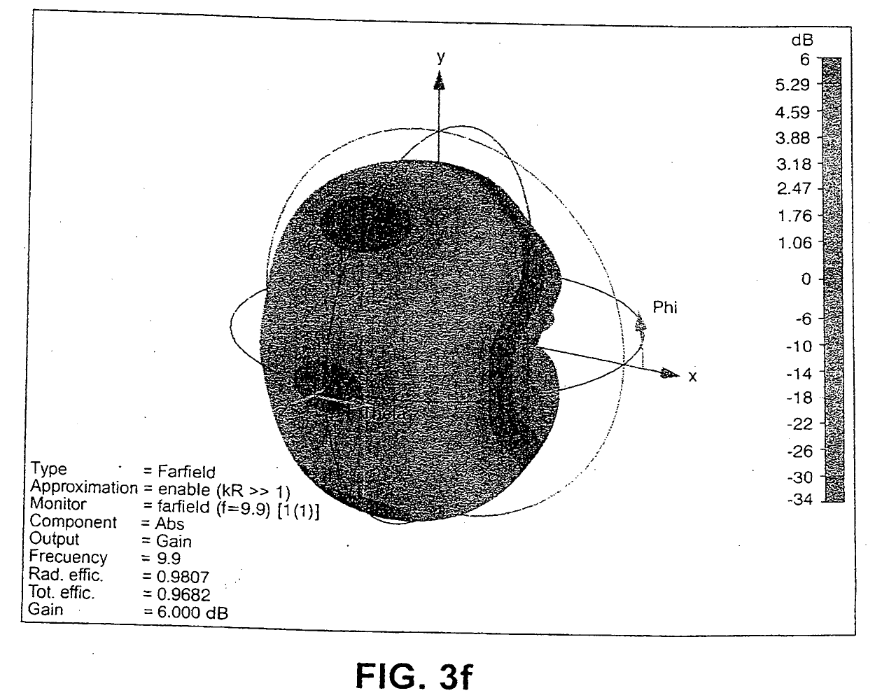

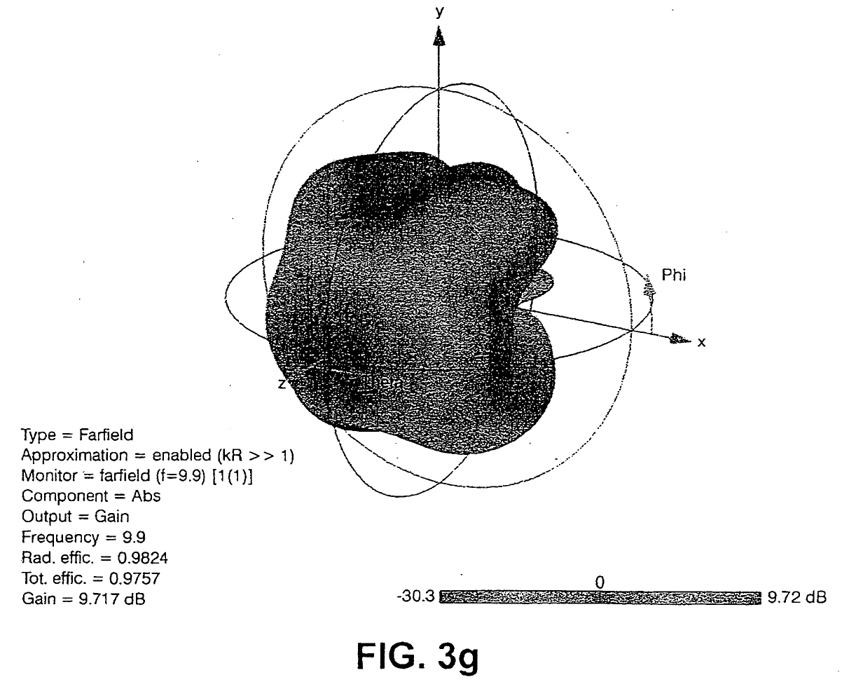

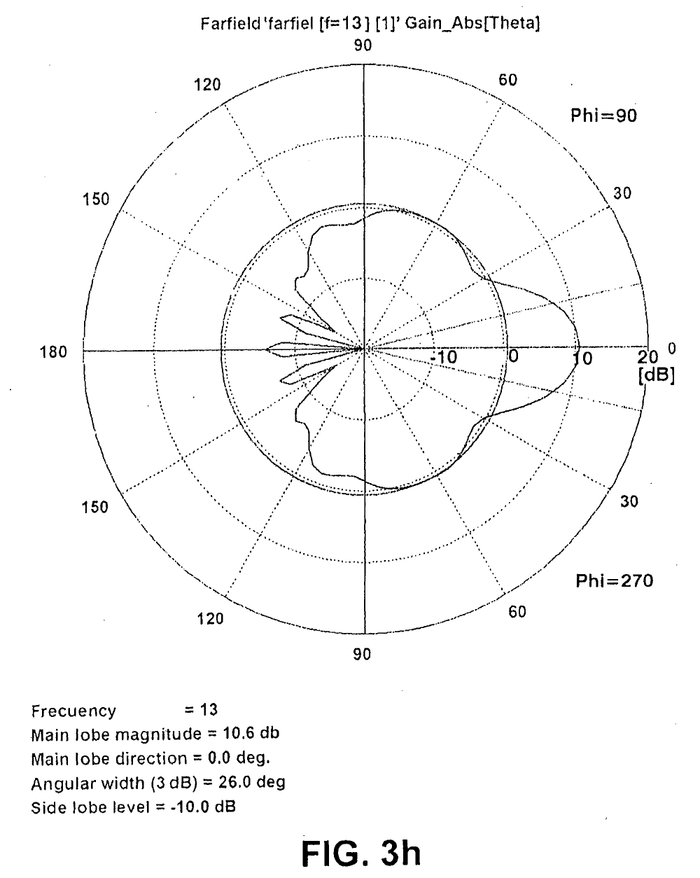

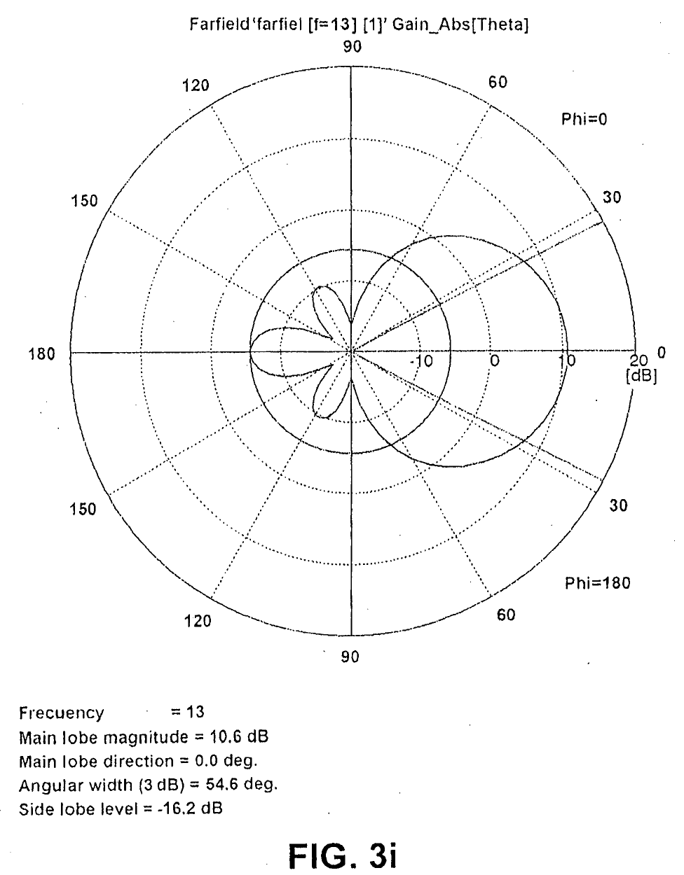

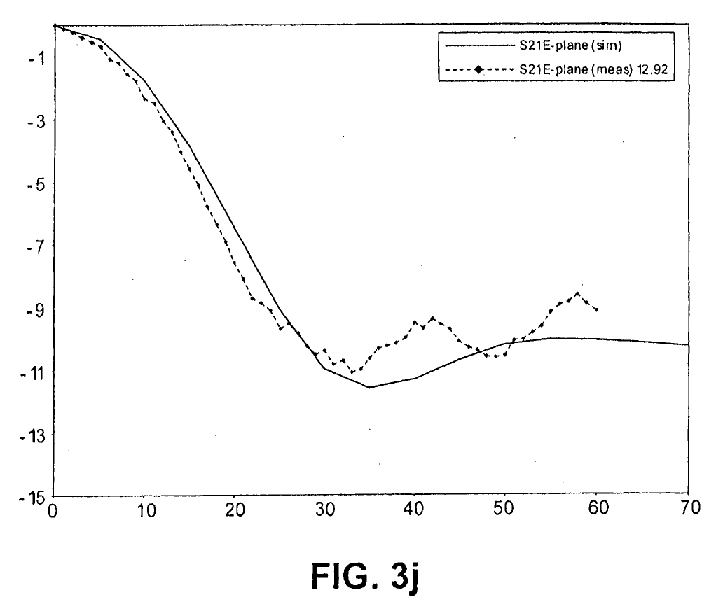

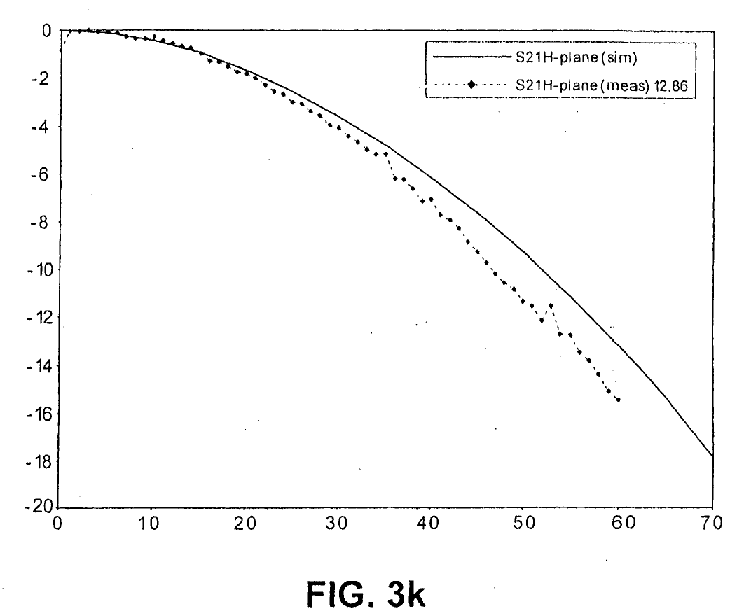

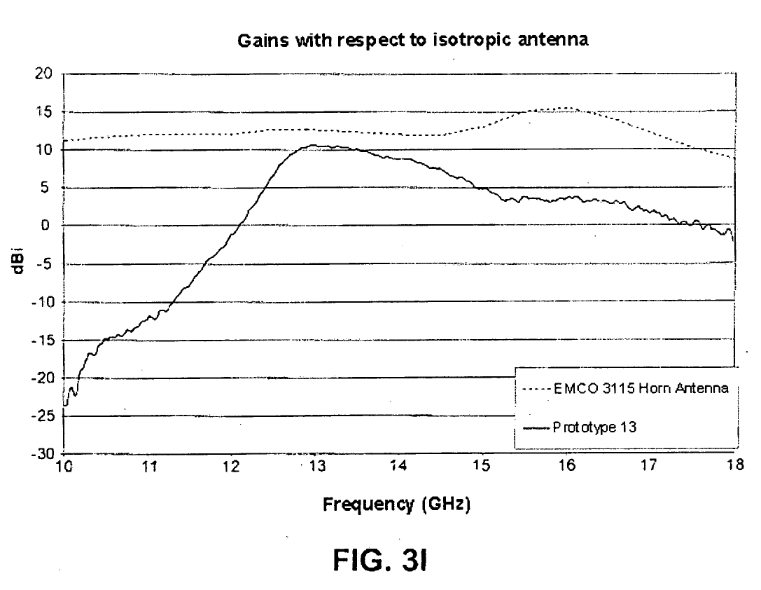

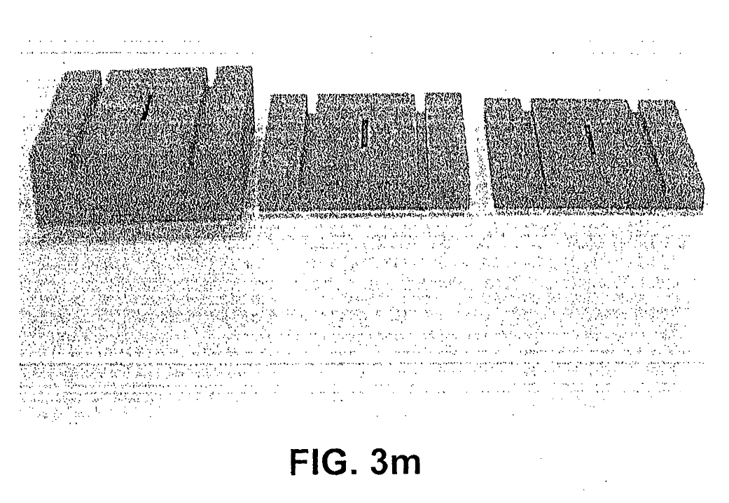

The most immediate way to design this antenna consists of a waveguide coupled by longitudinal resonance, i.e. by means of the thickness of the metallic plate separating the inside of the guide from free space, as is shown in FIG. 3a. For the purpose of minimizing the structure, only one corrugation has been included on each side of the slot on the metallic plate in this embodiment. Since the slot has a half-wavelength depth and acts as a Fabry-Perot resonator in its fundamental resonance, a power coupling exists as shown in FIG. 3b. Said outer corrugations exert only a collimating effort on the diffracted power in the form of a surface wave on the back side.

In an example of applying the antenna in mobile communication bands, the resulting wavelength is high, which makes a compact design unfeasible, the design being appropriate for frequencies in the millimetric wave range given that the thickness of the metal of the antenna is about a few millimeters. Therefore, for application in the microwave range it is necessary to reduce the thickness of the metal, keeping the radiation features intact, achieving a different resonance at the working frequency and thus not being obliged to maintain a minimum thickness of the metallic structure. To resolve this, the slot is made to resonate in the transverse direction rather than to resonate longitudinally, said transverse resonance being directly related to the width of the slot, as can be seen in FIGS. 3c and 3d.

FIG. 3e shows the response in frequencies and in said figure two resonances are observed, one corresponding to the transverse resonance associated to the width of the slot, and the other one, which occurs at a higher frequency, is the longitudinal resonance associated to the thickness of the slot. This allows the antenna to work in two frequency bands, being necessary to adjust the corrugations to the chosen band.

To optimize far-field radiation it is necessary to vary the distance between the slot and the corrugations. FIGS. 3f and 3g, equivalent to the three-dimensional radiation patterns for an isolated slot and another slot with corrugations, respectively, allow comparing the radiations of both. An isotropic radiation pattern is obtained for the case of a slot without corrugations (3f) whereas a collimated radiation pattern is observed for the case in which the corrugations have been provided (3g). The details of said patterns in the E and H planes are also shown in FIGS. 3h and 3i, in polar coordinate format, for the case with the presence of corrugations.

The good correspondence between the simulation and the measurements performed in an anechoic chamber are shown in FIGS. 3j and 3k for the E and H planes, respectively, in Cartesian coordinate format, i.e. the antenna sweeping angle on the x-axis and the signal level related to the maximum in decibels on the y-axis.

The gain of the antenna object of the invention has also been compared in frequency with a considerably larger horn antenna, as can be seen in FIG. 3l.

FIG. 3m finally shows different manufactured designs demonstrating the possibility of making intrinsically planar and compact models.

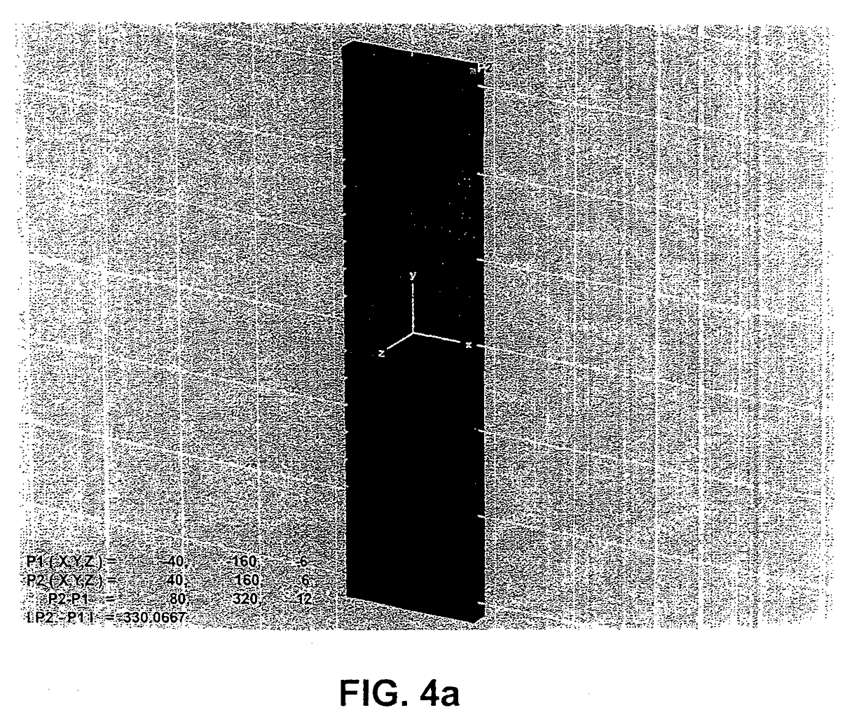

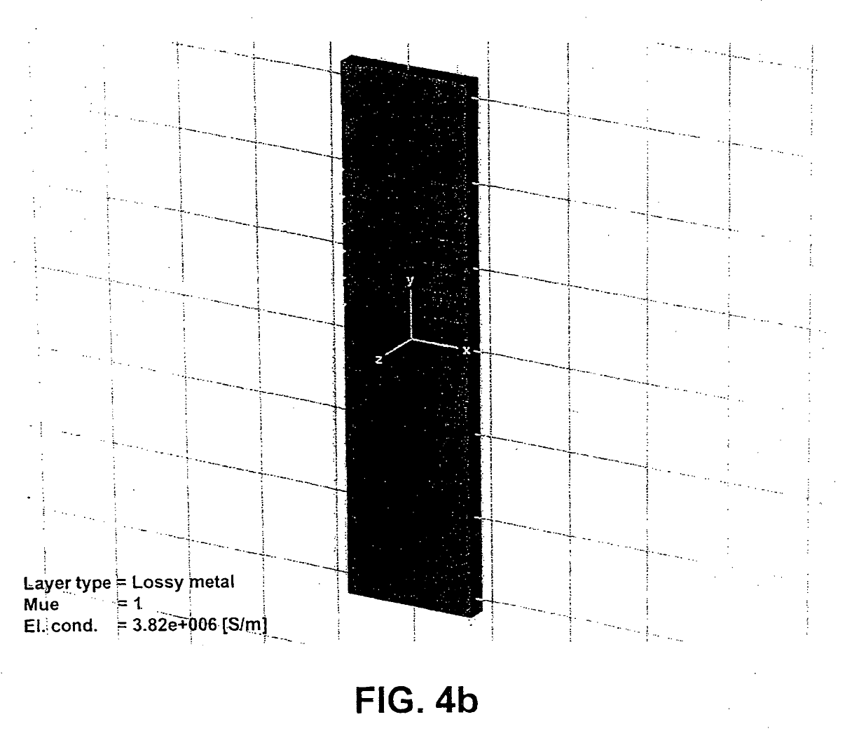

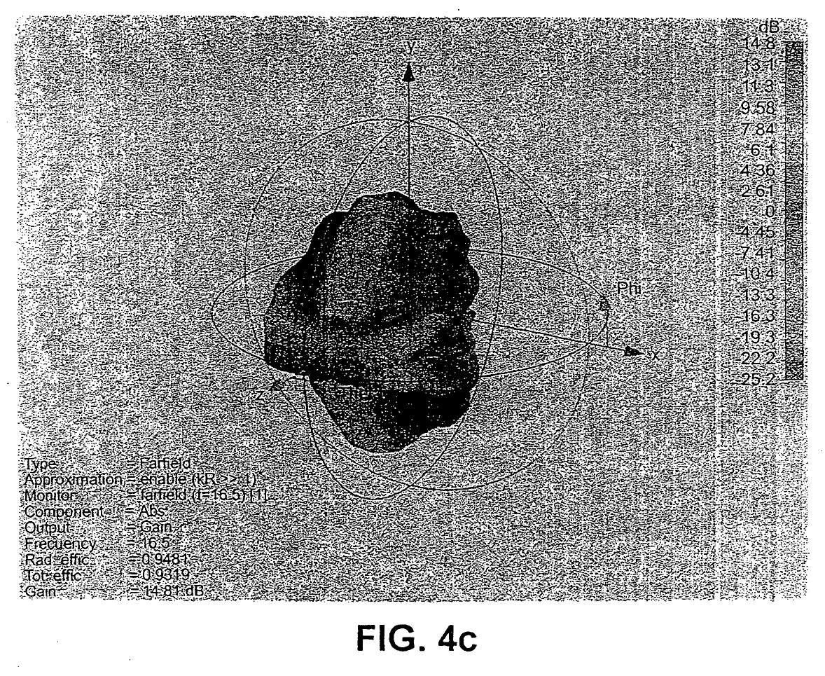

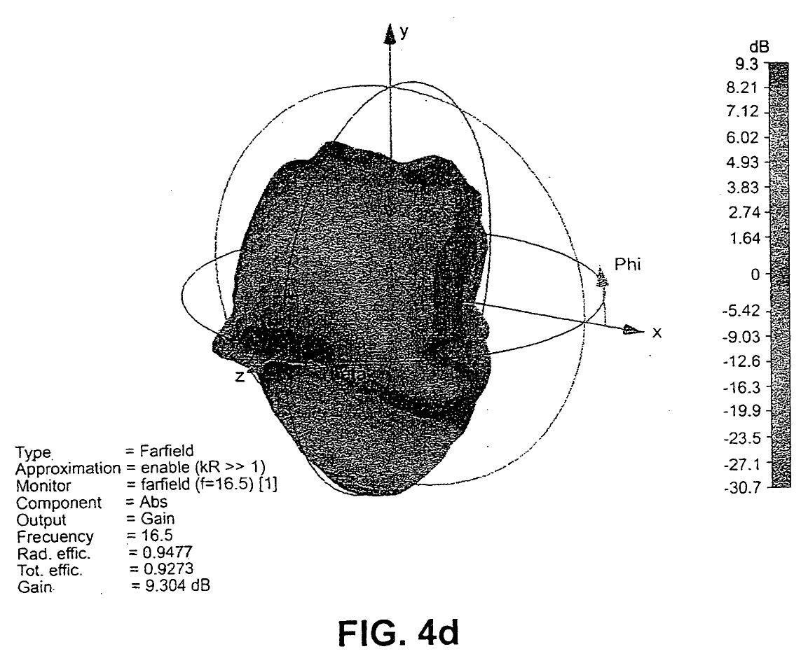

A larger number of corrugations are used in the embodiment example shown in FIGS. 4a and 4b, obtaining considerable improvement in collimation, as can be seen in the three-dimensional far-field radiation pattern of FIG. 4c. FIG. 4d shows the three-dimensional far-field radiation pattern of the antenna of FIG. 4b, thus demonstrating the possibility of obtaining asymmetrical collimation by means of the use of an asymmetrical corrugated structure, i.e. with corrugations only on one of the sides of the slot.

After the foregoing description it is possible to make an antenna that is capable of operating at two independent frequency bands by taking advantage of the fact that two independent resonances, longitudinal resonance and transverse resonance, can be excited in the slot, it further being possible to obtain a focus at different frequencies by means of regulating corrugation distance and depth.

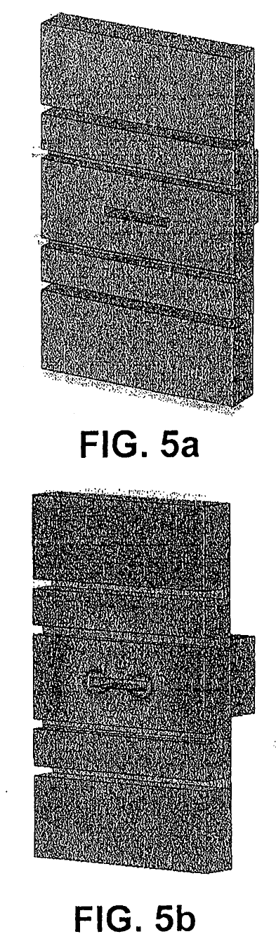

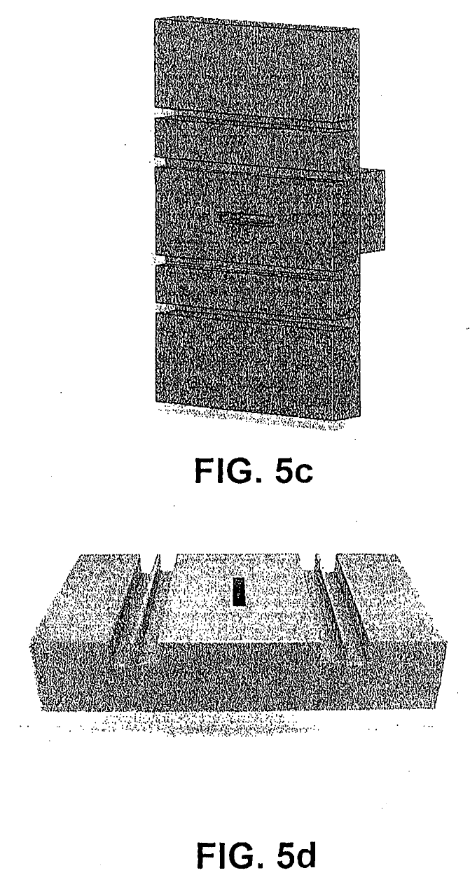

FIG. 5a shows a planar antenna such as the one previously described in which additional corrugations have been introduced, specifically an additional corrugation one each side of the slot for the purpose of achieving focalization at another frequency such that the response in frequency is barely affected by the introduction of said additional corrugations. The current distributions for the two working frequencies are represented in FIGS. 5b and 5c.

In this antenna with two corrugations on each side of the slot, said corrugations are only excited at the frequency that corresponds to them and are transparent for the other resonance. It is appropriate to point out that as in the case of the previous antenna with only one corrugation on each side of the slot, its corresponding three-dimensional far-field radiation patterns at both frequencies improve with respect to those that are obtained without corrugations.

In the previous dual-band antenna it is possible to fix, completely independently from one another, its resonance frequencies by means of controlling the width and thickness of the central slot, the corrugations being sensitive only to their design frequency and transparent for the other resonance. FIG. 5d shows a manufactured dual-band antenna design.

To achieve proper working it is indispensable to respect a minimum quarter wavelength width in order to be able to excavate corrugations in the metal, this condition possibly making the antenna unfeasible for certain applications in which the ultraplanar nature of the antenna is fundamental.

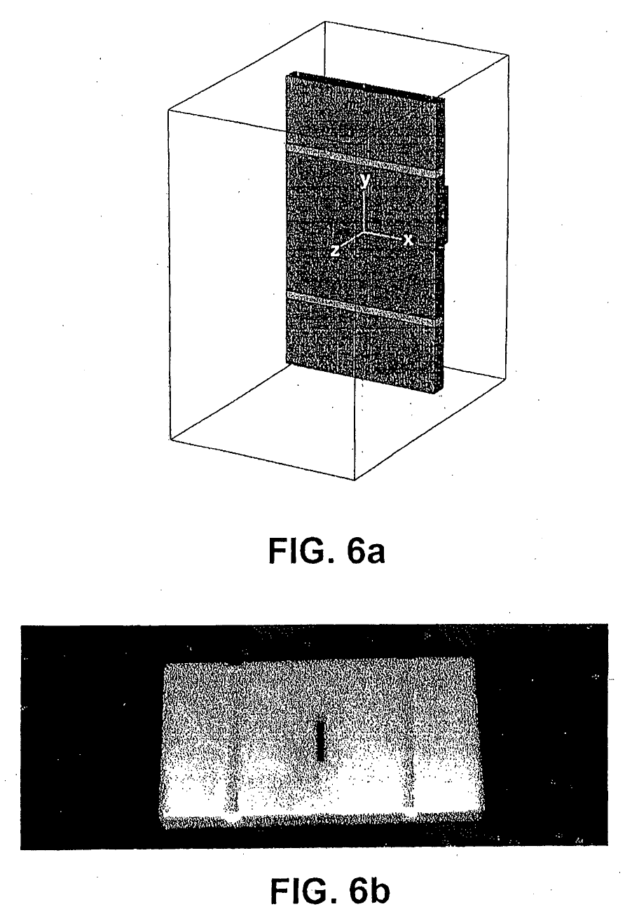

In order to resolve the foregoing, the introduction of a dielectric element with low losses and suitable relative dielectric permittivity inside the cavity formed by the corrugations is proposed. The introduction of said dielectric element allows a considerable reduction of thickness, as can be observed in FIG. 6a and in the photograph of FIG. 6b, in which a manufactured ultraplanar antenna prototype is shown.

Due to the properties previously described it is possible to make a planar antenna which prevents feeding the antenna with a waveguide, allowing the application of planar antennas to planar and monolithic circuits by means of a completely planar design on a microwave substrate with corrugations excavated on the substrate and subsequent metallization, being possible to include via-holes facilitating connection between plates.

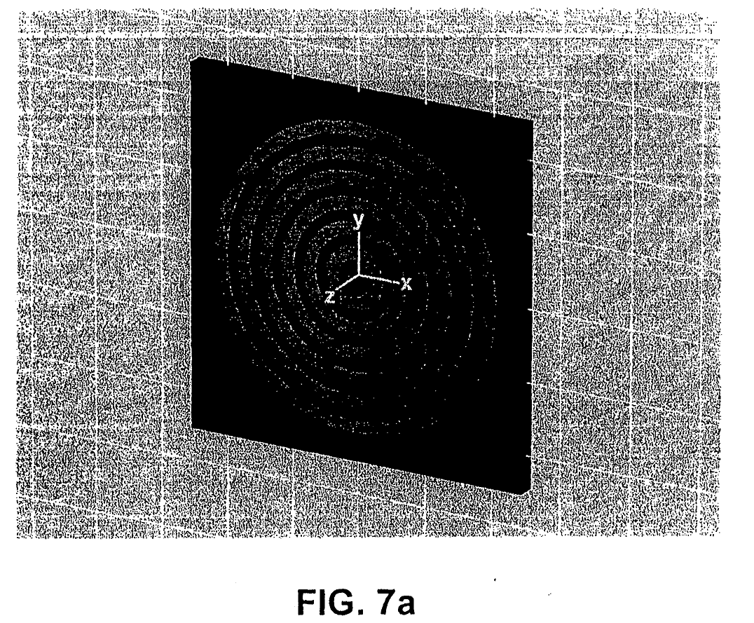

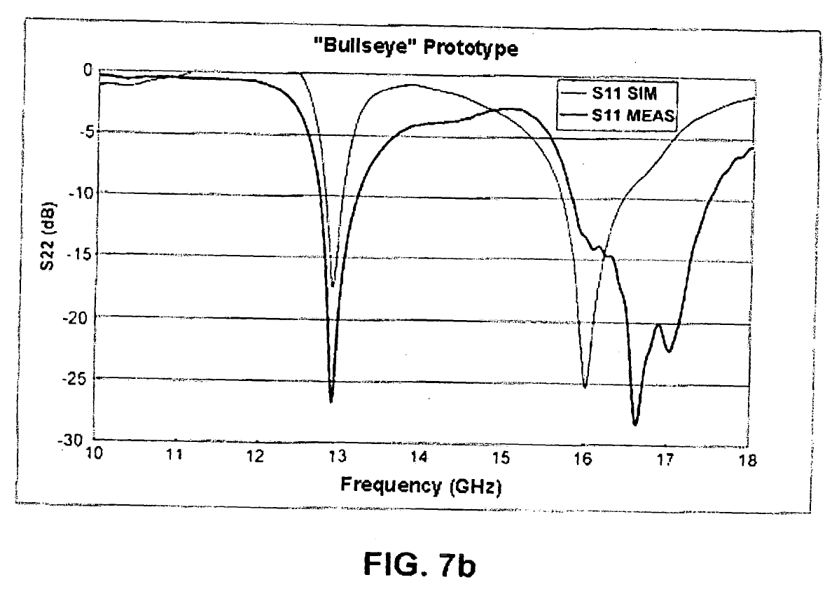

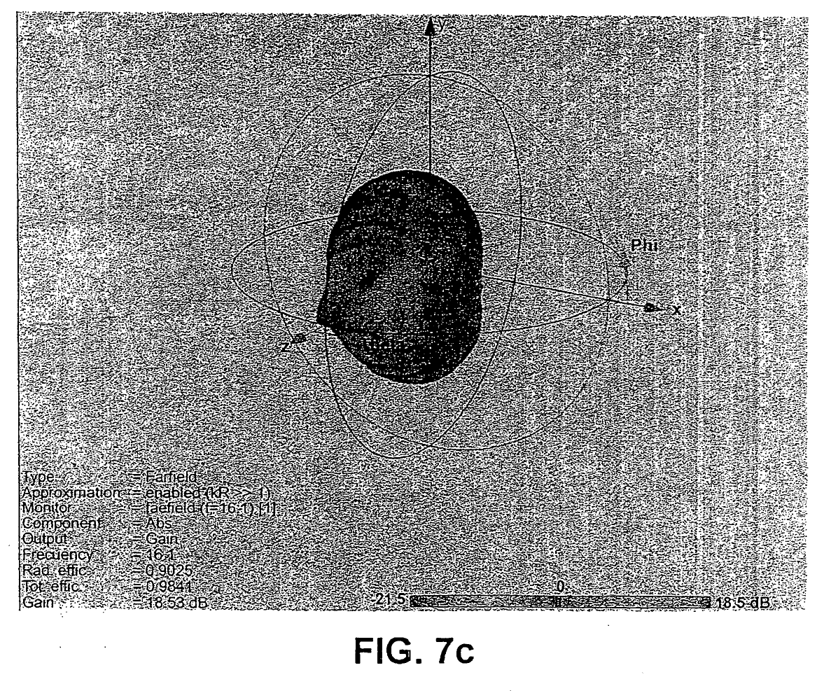

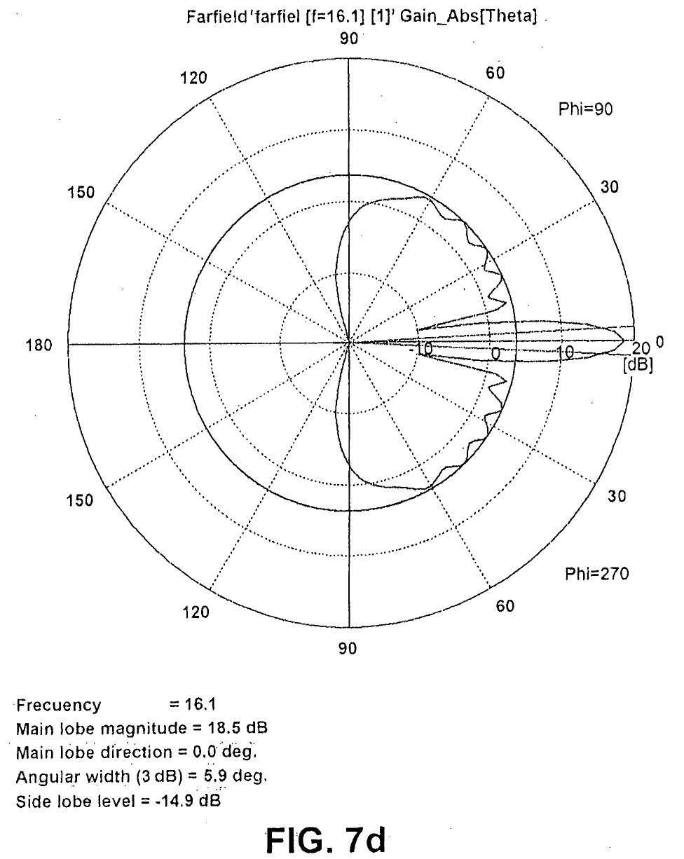

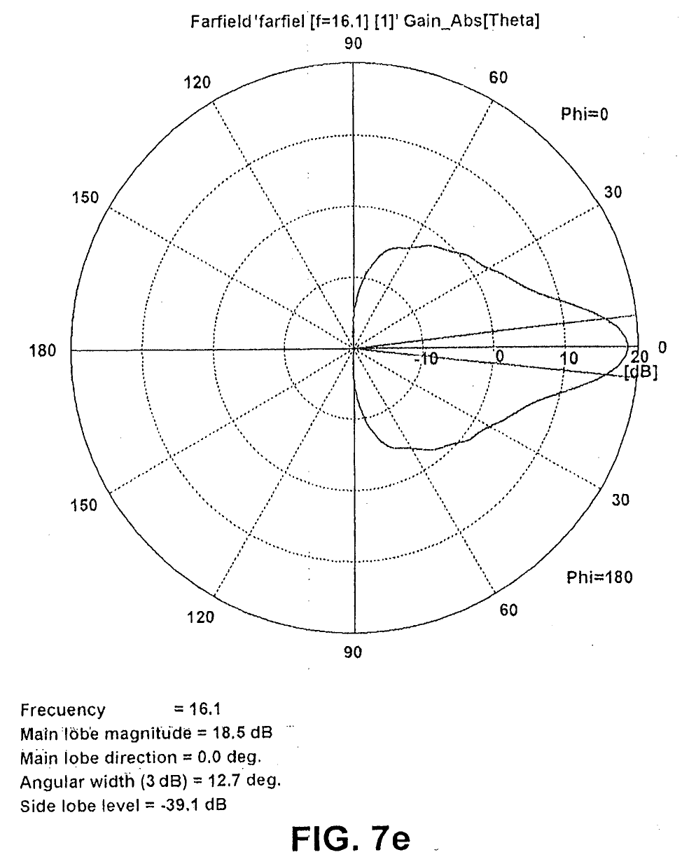

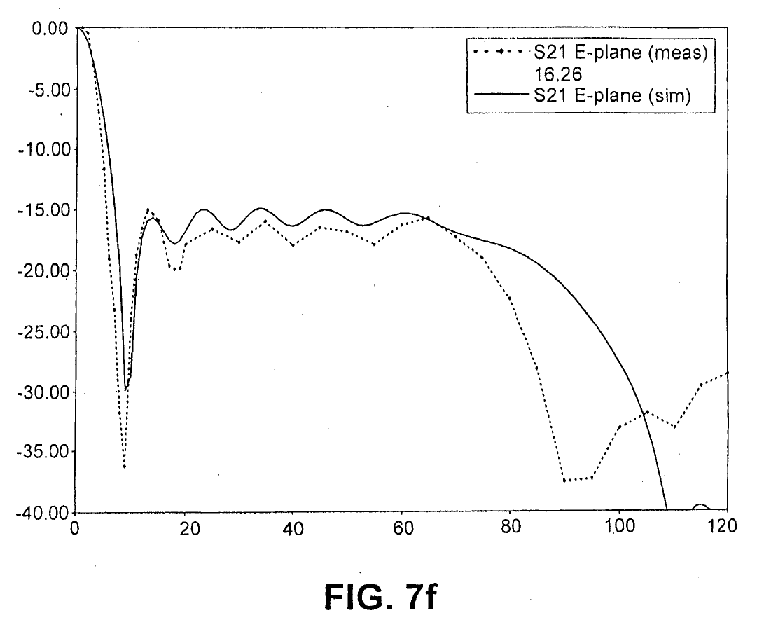

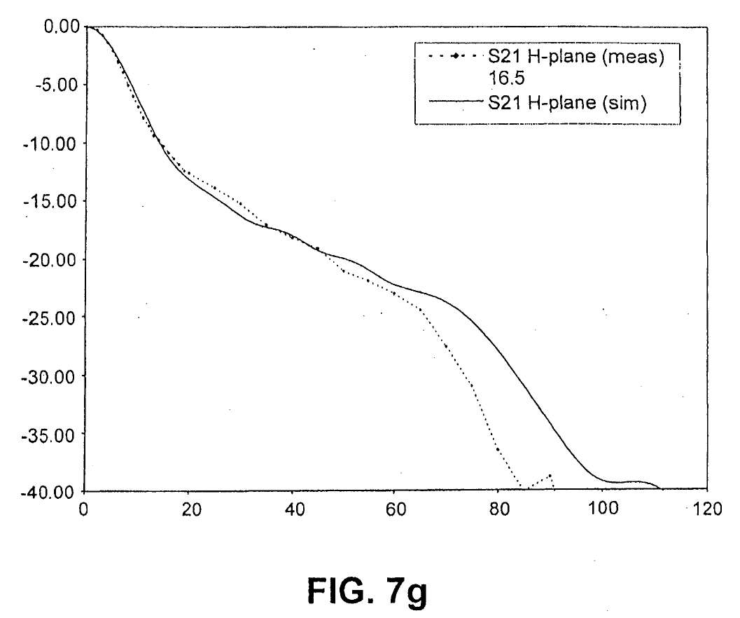

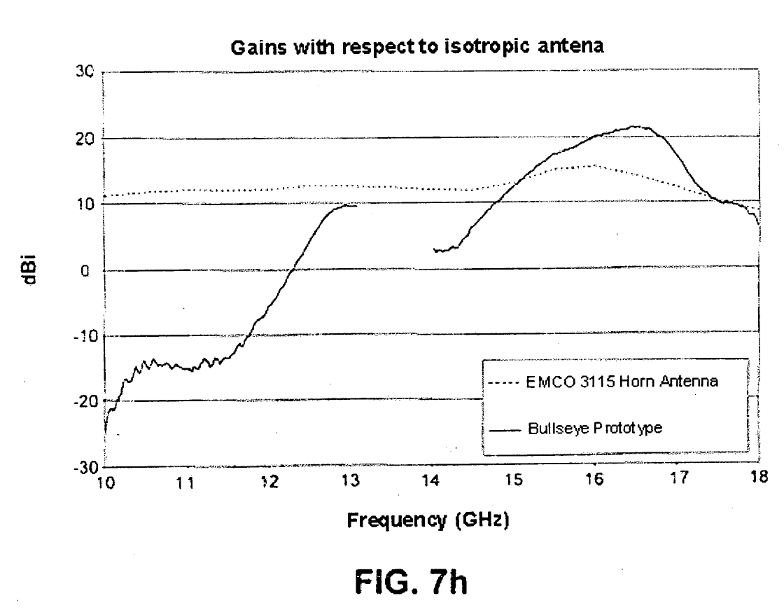

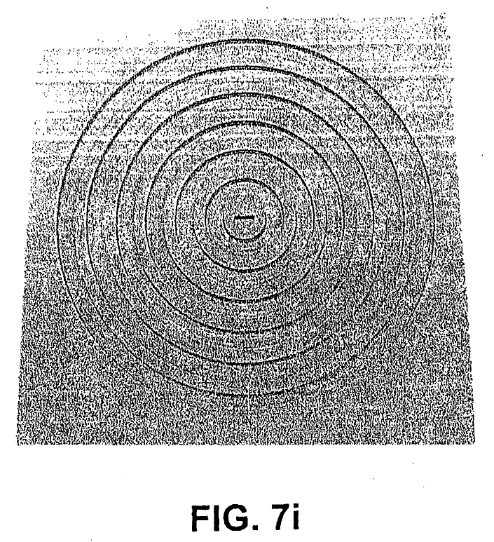

It is also possible to carry out a planar antenna design by using concentric corrugations around the slot with transverse and longitudinal resonance, as can be seen in FIG. 7a. FIG. 7b shows the response in frequencies, two resonances being observed corresponding to the transverse and longitudinal modes. The collimating effect of this antenna is much more pronounced than the previous designs, as can be seen in FIGS. 7c to 7e, in which the simulations of the three-dimensional E-plane (7d) and H-plane (7e) far-field radiation pattern are represented. The simulations have been confirmed by the measurements carried out, as can be seen in FIGS. 7f and 7g, for the far-field radiation pattern for the E and H planes, respectively, represented in Cartesian coordinates.

The gain of the antenna object of the invention has also been compared in frequency with a horn antenna of evidently larger dimensions, as can be seen in FIG. 7h.

FIG. 7i finally shows a manufactured design of this antenna.

The planar structure of the previously described antennas can be used without a connection to a waveguide or to a circuit, simply as a selective surface receiving the waves in free space and allowing those which have a given frequency and given angle of incidence pass. Any of the previously described embodiments can be applied to this selective surface.

1. An antenna of a planar profile used for the emission and reception of electromagnetic waves, preferably in the millimetric wave and microwave ranges, characterized in that it comprises a planar surface of little thickness with at least one thin slot traversing the planar surface of little thickness, the length of said thin slot being less than the wavelength of the emitted and received wave, and said planar surface having at least one pair of corrugations around the thin slot such that the electromagnetic wave is emitted and received by means of resonance through said slot.

2. An antenna according to claim 1, characterized in that the resonance through the slot is longitudinal.

3. An antenna according to claim 1, characterized in that the resonance through the slot is transverse.

4. An antenna according to claim 1, characterized in that it has a waveguide connected for the emission and reception of electromagnetic waves.

5. An antenna according to claim 1, characterized in that it has at least two pairs of corrugations and it combines transverse and longitudinal resonance so as to operate simultaneously in at least two different frequencies.

6. An antenna according to claim 1, characterized in that it inside the corrugations it has a material with an index of refraction different from that of the air.

7. An antenna according to claim 1, characterized in that inside the waveguide it has a material with an index of refraction different from that of the air.

8. An antenna according to claim 1, characterized in that the corrugations are symmetrical with respect to the transverse axis of the antenna.

9. An antenna according to claim 1, characterized in that the corrugations are located only on one side of the transverse axis of the antenna.

10. An antenna according to the previous claims, characterized in that the corrugations are straight.

11. An antenna according to claim 1, characterized in that the corrugations are curved and are arranged around the thin slot.

12. An antenna according to claim 1, characterized in that it is coupled to a planar technology circuit by means of the resonant slot.

13. An antenna according to claim 1, characterized in that it is coupled to a monolithic circuit carried out by means of monolithic integrated circuit manufacturing processes by means of the resonant slot.

14. An antenna according to claim 1, characterized in that it is made by means of micromachining manufacturing processes.

15. An antenna according to claim 1, characterized in that it is of a metallic material.

16. An antenna according to claim 1, characterized in that the corrugation profile is rectangular.

17. An antenna according to claim 1, characterized in that the corrugation profile is triangular.

18. An antenna according to claim 1, characterized in that the corrugation profile is sinusoidal.

19. An antenna according to claim 1, characterized in that it incorporates active elements, such as MEMS-type (Micro-Electromechanical Systems) electromechanical microswitches.

20. A frequency selective surface characterized by comprising an extensive slot on a metallic plate which allows handling electromagnetic waves for the purpose of carrying out a frequency filtering.
